(19) United States
(12) Patent Application Publication
(10) Pub. No.: US 2025/0136059 A1
(43) Pub. Date: May 1, 2025

(54) ON-VEHICLE CAMERA CLEANING DEVICE AND METHOD OF USE

(71) Applicants: Andrew Lavanture, Springville, NY (US); Andrew Tillinghast, Buffalo, NY (US)

(72) Inventors: Andrew Lavanture, Springville, NY (US); Andrew Tillinghast, Buffalo, NY (US)

(21) Appl. No.: 18/383,598

(22) Filed: Oct. 25, 2023

(51) Int. Cl. B60S 1/56; B60S 1/46; G02B 27/00

(52) U.S. Cl. CPC B60S 1/56; B60S 1/46; G02B 27/0006

(57) ABSTRACT

The present invention provides an on-vehicle camera cleaning device. The on-vehicle camera cleaning device has a body with a surface dedicated to attached against a vehicle mounted camera housing. Extending from the body is a sprayer section that curves slightly in order to route the washer fluid in the direction of a camera lens. This extension from the body has an opening (i.e., spray nozzle opening) to allow fluid to exit the device and clean the camera lens. On the opposite side of the sprayer section, there is a nipple that protrudes out in order to attach a hose to supply the spray nozzle with the washer fluid when operated. The entire body of the sprayer section is hollow to allow the fluid to flow from the nipple to a spray nozzle.

### FIELD OF THE INVENTION

The present invention relates to an on-vehicle camera cleaning device that supplies washer fluid to a lens of a camera thereby removing foreign matter on the camera, the device has a body, and a spray nozzle.

### BACKGROUND OF THE INVENTION

Vehicle-based technologies have made huge advancements in various manners whether it's related to performance, quality, or even comforts provided by the vehicles. There was a time when vehicles lacked basic provisions but now vehicle manufacturers are trying their best to provide additional/state-of-the-art features in the vehicles to provide the best possible vehicles to the consumers. A vast improvement can easily be noticed that the vehicles nowadays are being introduced in the market with pre-installed cameras. These pre-installed cameras are being used for real-time monitoring for accident prevention/mitigation, navigation purposes, parking, and plenty of other camera-related applications in vehicles.

These cameras need proper care so that they function smoothly and hence the consumer doesn't have to face any issues due to malfunctioning cameras which may cause road fatality or any other serious problem. To keep the cameras glitch-free, an essential action to be taken frequently is proper cleaning of the cameras installed in the vehicles. These cameras are installed in a manner where they may be exposed to the external environment i.e., dirt and debris. The installation of these cameras may be at the front end or even at the rear end of the vehicles. These external environment elements tend to deter the camera's performance. The vehicle manufacturers usually do not provide any camera cleaning equipment pre-installed in the vehicles so that the cameras can be cleaned automatically or at least manually.

Therefore, the present invention has provided a spray nozzle-based solution for camera cleaning in vehicles. The spray nozzle is being controlled using the windshield washer controls.

### SUMMARY OF THE INVENTION

Accordingly, it is an objective of the present invention to provide a compact spray nozzle for the vehicle-mounted camera that is capable of reliably washing a lens of the camera mounted on a rear side of a vehicle. Another object of the present invention is to provide a universal camera cleaning device that can be fitted on any vehicle.

To achieve the above objective, a first aspect of the present invention provides a spray nozzle for removing accumulated foreign matter such as dirt, dust, mud, road salt, or built-up debris on the lens of the camera mounted on the outside of a vehicle by supplying washer fluid to the camera.

The on-vehicle camera cleaning device has a body with a surface dedicated to attached against a vehicle mounted camera housing. Extending from the body is a sprayer section that curves slightly to route the washer fluid in the direction of a camera lens. This extension from the body has an opening (i.e., spray nozzle opening) to allow fluid to exit the device and clean the camera lens. On the opposite side of the sprayer section, there is a nipple that protrudes out to attach a hose to supply the spray nozzle with the washer fluid when operated. The entire body of the sprayer section is hollow to allow the fluid to flow from the nipple to the spray nozzle. The geometry of the body, sprayer section, and nipple can vary depending on the camera housing the device is designed to attach to.

In one exemplary embodiment, the body is an elongated hollow body and the spray nozzle is enabled to discharge the washer fluid in an upward direction toward the lens of the camera.

In another exemplary embodiment, the device is attached to a vehicle mounted camera housing using a double-sided tape, epoxy or similar connecting medium.

### BRIEF DESCRIPTION OF THE DRAWINGS

Embodiments of the present invention described herein are exemplary, and not restrictive. Embodiments will now be described, by way of examples, with reference to the accompanying drawings. In these drawings, each identical or nearly identical component that is illustrated in various figures is represented by a reference number. For purposes of clarity, not every component is labeled in every drawing. The drawings are not necessarily drawn to scale, with emphasis instead being placed on illustrating various aspects of the techniques and devices described herein.

The foregoing and other objects, aspects, and advantages are better understood from the following detailed description of a preferred embodiment of the invention with reference to the drawings, in which:

FIG. 1 illustrates a perspective view of an on-vehicle camera cleaning device, in accordance with a preferred embodiment of the present invention.

FIG. 2 is a perspective view of the sprayer section, in accordance with an exemplary embodiment of the present invention.

FIG. 3 is a front side view of the on-vehicle camera cleaning device, in accordance with an exemplary embodiment of the present invention.

FIG. 4 shows a vehicle with the camera located at a rear side of the vehicle according to an embodiment of the present invention.

FIG. 5 is a perspective view of a truck (different version of spray nozzle section) sprayer, in accordance with an exemplary embodiment of the present invention.

FIG. 6 depicts a flow diagram of an exemplary method for installing an on-vehicle camera cleaning device on a car or truck, in accordance with an exemplary embodiment of the present invention.

### DETAILED DESCRIPTION OF THE INVENTION

With reference to the figures provided, embodiments of the present invention are now described in detail. In the following description, for the purpose of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purpose of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features.

Embodiments of the present invention relate to an aftermarket on-vehicle camera cleaning device for cleaning the vehicle-mounted camera. In one exemplary embodiment of the present invention, the camera mounted on the vehicle can be cleaned by the cleaning device is the reversing camera positioned at the rear of the vehicle and oriented to capture images of a road scene extending to a rear side of a vehicle. In one exemplary embodiment of the present invention, the camera that can be cleaned by the cleaning device is a front camera positioned at a front side of the vehicle and oriented to capture images of a road scene extending to the front of the vehicle. Another object of the present invention is to provide a universal camera cleaning device that can discharge the washer fluid downwards towards a lens surface of a camera mounted on a vehicle.

An object of the present invention is to provide a method of installation of the aftermarket on-vehicle camera cleaning device on a vehicle. In another exemplary embodiment of the present invention, the vehicle is a car. The installation method for a car comprises accurately drilling a hole through a specific point of the car. The hole is drilled out with the help of a vehicle specific template. A fluid hose carrying washer fluid can be fed through the hole towards the car's exterior or the car's camera. A vehicle specific spray nozzle is secured at the bottom of the camera housing of the car, using epoxy or other suitable adhesive means in a position where the spraying end of the nozzle faces the camera of the car. The fluid is siphoned out of the fluid reservoir of the car with the help of an arrangement that entails cutting the OEM washer fluid line of the car at a point between the OEM washer fluid pump and the OEM rear windshield spray nozzle. At the point where the fluid line is cut, a T-Fitting is installed leaving one end of the T-fitting exposed. The exposed end of the T-Fitting is connected to the sprayer nozzle via a 6″ section of washer fluid hose. The T-Fitting is equipped with an on/off ball valve that is connected to the 6″ section of hose, responsible for turning on/off the flow of the fluid. A one-way check valve installed to the 6″ section of the fluid hose facilitates the flow of the fluid in the direction of the sprayer.

In another exemplary embodiment of the present invention, the vehicle is a truck. The installation method for a truck requires first removing the tailgate assembly camera housing from the truck. A hole for the sprayer nozzle is drilled out of the tailgate assembly camera housing with the help of a vehicle specific drill template. The sprayer nozzle is then fixed to the tailgate assembly via a ½″ nut in such a position that the spraying end of the sprayer nozzle aims towards the camera. The tailgate assembly camera housing is then re-installed on the truck. The fluid is siphoned out of the fluid reservoir of the truck via an arrangement that entails cutting the OEM washer fluid line of the truck at a point between the OEM washer fluid pump and the OEM windshield spray nozzle. At the point where the fluid line is cut, a T-Fitting is installed leaving one end of the T-fitting exposed. The exposed end of the T-Fitting is connected to the sprayer nozzle via a 6″ section of washer fluid hose. The T-Fitting is equipped with an on/off ball valve that is connected to the 6″ section of hose, responsible for turning on/off the flow of the fluid. A one-way check valve installed to the 6″ section of the fluid hose facilitates the flow of the fluid in the direction of the sprayer.

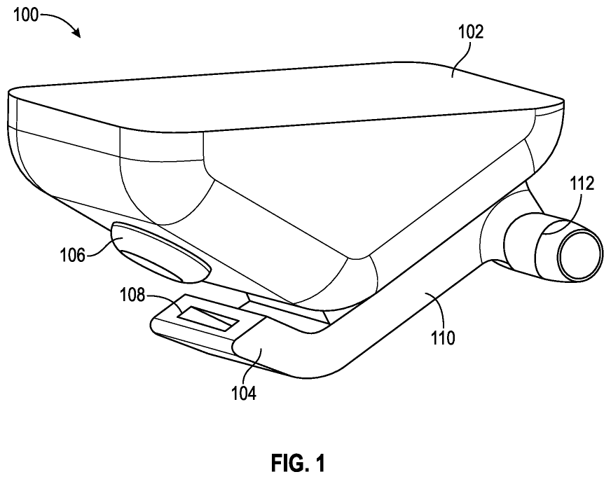

FIG. 1 illustrates a perspective view of an on-vehicle camera cleaning device (100), in accordance with a preferred embodiment of the present invention. The on-vehicle camera cleaning device (100) comprises a sprayer body (110), a nipple (112) and spray nozzle (104) designed to conform to the vehicle mounted camera housing (102). A double-sided tape or epoxy is enabled to attach the on-vehicle camera cleaning device (100) to the vehicle mounted camera housing (102). Extending from the camera housing body is a sprayer body (110) that curves slightly in order to route the washer fluid in the direction of a camera lens (106). The spray nozzle (104) has a spray nozzle opening (108) (i.e., spray nozzle opening) to allow fluid to exit the on-vehicle camera cleaning device (100) and clean the camera lens (106). On the opposite side of the sprayer body (110), there is a nipple (112) that protrudes out to attach to a vehicle's washer fluid supply line and a path through the sprayer body (110) to allow fluid to flow from the nipple (112) to the spray nozzle opening (108). The path linearly extends from the nipple towards the spray nozzle opening (108). The entire body of the sprayer body (110) is hollow to allow the fluid to flow from the nipple (112) to the spray nozzle (104).

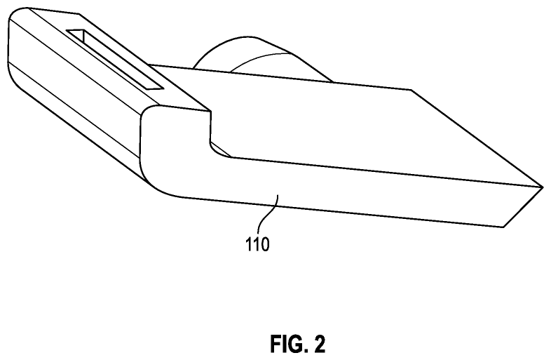

FIG. 2 is a perspective view of the sprayer body (110), in accordance with an exemplary embodiment of the present invention.

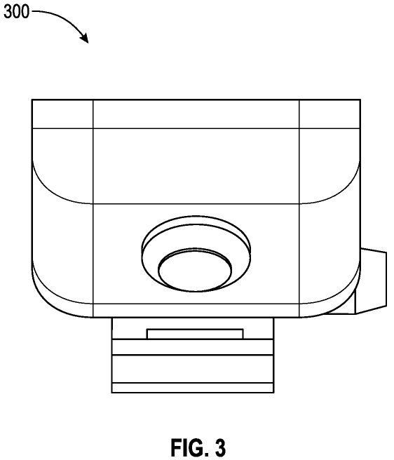

FIG. 3 is a front side view (300) of the on-vehicle camera cleaning device, in accordance with an exemplary embodiment of the present invention.

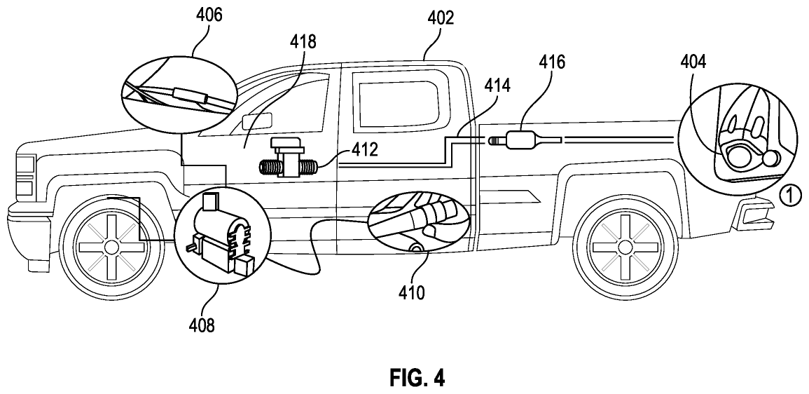

FIG. 4 shows a vehicle (402) with the camera (404) located at a rear side of the vehicle (402) according to an embodiment of the present invention. In this example, the camera (404) is capable of capturing an image of an environment at the back of the vehicle (402). The image may be displayed on a video screen within a vehicle and aid a driver in seeing objects located in the path of the vehicle (402). The image generated by the camera (404) may be a real time image or a video. The vehicle (402) comprises a washer fluid reservoir to hold the washer fluid. The washer fluid reservoir is located in the engine compartment of the vehicle (402) to clean the front windshield (406) of the vehicle (402).

The vehicle's washer fluid reservoir is connected to a washer fluid pump (408). In one example, the washer fluid pump (408) is fluidly connected to the spray nozzle via a ball valve (412). The washer fluid pump (408) is actuated to draw the washer fluid from the washer fluid reservoir and deliver it to the spray nozzle. The ball valve (412) can be used to control the flow of the washer fluid from the vehicle's washer fluid reservoir to the spray nozzle. The spray nozzle is configured to deliver a spray of suitable force and coverage to clean the camera lens. In one embodiment, the spray nozzle may be located below and/or to the sides of the camera lens. The washer fluid pump (408) is actuated by a driver using a button (410), or a switch located in the vehicle cabin. Wherein the button (410) is the OEM washer fluid turn on switch of the vehicle itself. When the washer fluid pump (408) is activated in response to the operation of the button (410), washer fluid drawn through the washer fluid reservoir is transferred to the T-fitting (418) and from there splits to supply fluid to the sprayer nozzle and the windshield.

In one example, the button (410) is configured to transmit a signal to the washer fluid pump (408) to transfer the fluid from the vehicle's washer fluid reservoir of the vehicle (402) to the nipple through the vehicle's washer fluid supply line (414). Further, a path through the device allows fluid to flow from the nipple to the spray nozzle opening. The path linearly extends in the device from the nipple to the spray nozzle opening. A control valve (416) is located near the sprayer. The control valve (416) can be either a check valve or a solenoid valve. A check valve is used to supply back pressure to resist the flow out of the sprayer when the washer fluid pump (408) is not activated, thereby stopping the supply of the washer fluid. The check valve is a ball and spring type that allows fluid to flow one way. The ball and spring also create back pressure and prevent unwanted fluid from leaking out when the pump is not activated. A solenoid valve can also be used for this purpose because a solenoid valve is a “normally closed” valve. Another feature that would make solenoid valve useful is that it can be activated by an electronic signal when the truck is in reverse. Thus the valve would open and allow fluid to flow only when the vehicle is in reverse. This would be necessary for the truck systems to prevent fluid from flowing to the sprayer when not in reverse.

The ball valve (412) is located between the T-fitting (418) and the sprayer and allows the flow of fluid to be shut off or turned on as desired. In another example, the washer fluid reservoir is located at the rear side of the vehicle to clean the rear windshield of the vehicle.

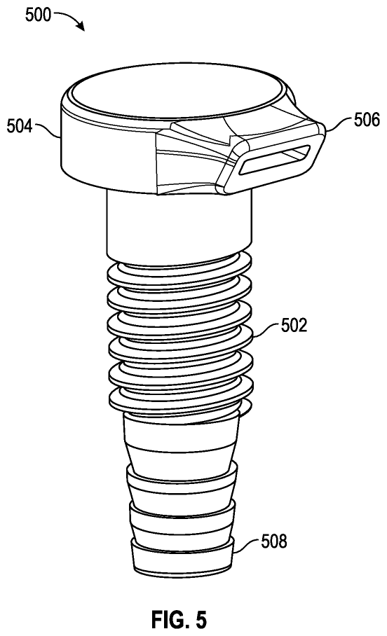

FIG. 5 is a perspective view of a truck sprayer (500), in accordance with an exemplary embodiment of the present invention. The truck sprayer (500) has a threaded body (502), a spray section (504), a nipple (508) to allow the fluid supply line to attach to the sprayer and a spray nozzle (506) which is slightly curved to point at the lens of the camera.

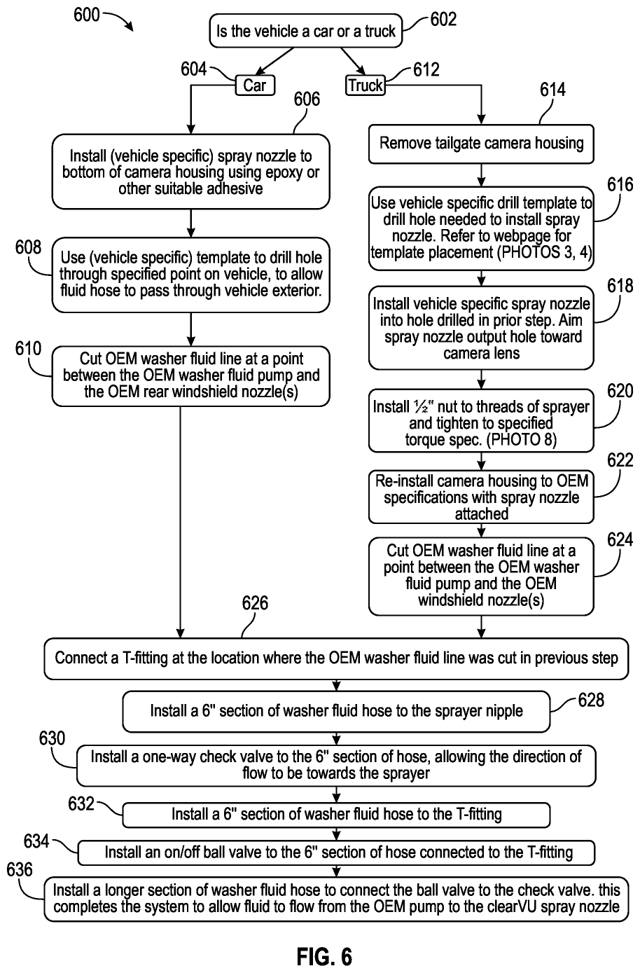

FIG. 6 depicts a flow diagram of an exemplary method for installing an on-vehicle camera cleaning device (600) on a car (604) or truck (612), in accordance with an exemplary embodiment of the present invention. At a step 602, vehicle type such as a car (604) or truck (612) is first determined. If at the step 602, a car (604) is determined, then at a step 606, install (vehicle specific) spray nozzle to bottom of camera housing using epoxy or other suitable adhesive. Then at a step 608, use (vehicle specific) template to drill hole through specified point on vehicle, to allow fluid hose to pass through vehicle exterior. Then at a step 610, cut OEM washer fluid line at a point between the OEM washer fluid pump and the OEM rear windshield nozzle(s).

If at the step 602, a truck (612) is determined, then at a step 614, remove tailgate camera housing. Then, at a step 616, use vehicle specific drill template to drill hole needed to install spray nozzle. Refer to webpage for template placement. Then, at a step 618, install vehicle specific spray nozzle into hole drilled in the step 616. Aim spray nozzle output hole toward camera lens. Then, at a step 620, install ½″ nut to threads of sprayer and tighten to specified torque spec. Then, at a step 622, re-install camera housing to OEM specifications with spray nozzle attached. Then, at a step 624, cut OEM washer fluid line at a point between the OEM washer fluid pump and the OEM windshield nozzle(s).

Following the completion of the aforementioned vehicle-specific steps, both the car (604) and the truck (612) will continue to a step 626. In the step 626, connect a T-fitting at the location where the OEM washer fluid line was cut in the step 610 if the vehicle type is a car (604) or the step 624 if vehicle type is a truck (612). Then, in a step 628, install a 6″ section of washer fluid hose to the sprayer nipple. Then, in a step 630, install a one-way check valve to the 6″ section of hose, allowing the direction of flow to be towards the sprayer. Then, in a step 632, install a 6″ section of washer fluid hose to the T-fitting. Then, in a step 634, install an on/off ball valve to the 6″ section of hose connected to the T-fitting. Lastly, in a step 636, install a longer section of washer fluid hose to connect the ball valve to the check valve. This completes the system to allow fluid to flow from the OEM pump to the clearVU spray nozzle.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

What is claimed is:

1. An aftermarket on-vehicle camera cleaning device on a vehicle, comprises:
a spray nozzle designed to conform to at least one side of a vehicle mounted camera housing, wherein the spray nozzle is designed to point at a lens of a camera of the on-vehicle camera cleaning device;
a fluid hose enabled to pass through an exterior of the vehicle, wherein a section of the fluid hose is coupled with a nipple of the spray nozzle;
a T-fitting enabled to be connected between an OEM washer fluid pump and the OEM rear windshield spray nozzle, wherein a section of the fluid hose is coupled with the T-fitting; and
a ball valve enabled to be coupled with the section of the fluid hose to control the flow of the fluid from the OEM washer fluid pump to the spray nozzle.

2. The on-vehicle camera cleaning device of claim 1 further comprises a one-way check valve coupled to the fluid hose, enabling the direction of the flow towards the spray nozzle.

3. The on-vehicle camera cleaning device of claim 1 further comprises a solenoid valve that is activated by an electronic signal when the vehicle is in reverse.

4. The on-vehicle camera cleaning device of claim 2 further comprises a longer section of the fluid hose to connect the ball valve to the check valve.

5. The on-vehicle camera cleaning device of claim 1, wherein the spray nozzle opening discharges washer fluid on the lens of the camera mounted on the vehicle to remove foreign matter.

6. The on-vehicle camera cleaning device of claim 1, wherein the spray nozzle opening is configured to discharge washer fluid in a vertically upward direction.

7. The on-vehicle camera cleaning device of claim 1, wherein the camera is a rear-view camera attached to the rear of a vehicle.

8. The on-vehicle camera cleaning device of claim 1, wherein the spray nozzle is conformed to the vehicle mounted camera housing by connecting the spray nozzle by drilling a hole into the vehicle body after temporarily removing the vehicle mounted camera housing if type of the vehicle is a heavy motor vehicle.

9. The on-vehicle camera cleaning device of claim 1, wherein the spray nozzle is conformed to the vehicle mounted camera housing using epoxy or any adhesive if type of the vehicle is a light motor vehicle.

10. A method of connecting an aftermarket on-vehicle camera cleaning device on a vehicle, the method comprising
conforming a spray nozzle to at least one side of a vehicle mounted camera housing, wherein the spray nozzle is designed to point at a lens of a camera of the on-vehicle camera cleaning device;
connecting a fluid hose by drilling on exterior body of the vehicle, wherein a section of the fluid hose is coupled with a nipple of the spray nozzle;
connecting a T-fitting between an OEM washer fluid pump and an OEM rear windshield spray nozzle, wherein a section of the fluid hose is coupled with the T-fitting; and
coupling a ball valve with the section of the fluid hose to control the flow of the fluid from the OEM washer fluid pump to the spray nozzle.

11. The method of claim 10 further comprises coupling a one-way check valve with the fluid hose, enabling the direction of the flow towards the spray nozzle.

12. The method of claim 11 further comprises connecting a longer section of the fluid hose with the ball valve to the check valve.

13. The method of claim 10, wherein the spray nozzle opening discharges washer fluid on the lens of the camera mounted on the vehicle to remove foreign matter.

14. The method of claim 10, wherein the spray nozzle opening is configured to discharge washer fluid in a vertically upward direction.

15. The method of claim 9, wherein the camera is a rear-view camera attached to a rear of a vehicle.

16. The method of claim 10, wherein the spray nozzle is conformed to the vehicle mounted camera housing by connecting the spray nozzle by drilling a hole into the vehicle body after temporarily removing the vehicle mounted camera.

17. The on-vehicle camera cleaning device of claim 1, wherein the spray nozzle is conformed to the vehicle mounted camera housing using epoxy or any adhesive.

18. The method of claim 10 further comprises coupling a solenoid valve with the fluid hose that is activated by an electronic signal when the vehicle is in reverse
